(19) United States
(12) Patent Application Publication
(10) Pub. No.: US 2008/0101544 A1
(43) Pub. Date: May 1, 2008

(54) Collimator Methods and Apparatus

(76) Inventors: Scott Richard Wiese, Milwaukee, WI (US); John Scott Price, Niskayuna, NY (US)

Correspondence Address: Thomas M. Fisher;Fisher Patent Group LLC, 700 6th Street NW, Hickory, NC, 28601, US

(21) Appl. No.: 11/551,208

(22) Filed: Oct. 19, 2006

(51) Int. Cl. G21K 1/02

(52) U.S. Cl. 378/148

(57) ABSTRACT

A method includes receiving x-ray data from a detector, and responding substantially in real time to the received data by controlling an object's exposure to x-rays.

### BACKGROUND OF THE INVENTION

This invention relates generally to diagnostic imaging methods and apparatus, and more particularly, to methods and apparatus that provide for collimation.

Currently, the only method of attenuating x-rays in Computed Tomography (CT) systems or x-ray systems is through the use of a collimator. Advances in collimator technologies have allowed for better spatial control, though the ability to use fine control of patient exposure in response to real time information received from the detectors has been heretofore lacking. Therefore, it is desirable to provide methods and apparatus that provide for responding substantially in real time to the received data by controlling an objects exposure to x-rays, as explained in detail below. Also, in CT the device described below is very similar in function to a ‘bowtie filter’; the term bowtie refers to the greater thickness to the outside and smaller thickness to the inside, thus forming a bowtie of sorts when viewed in cross-section.

### BRIEF DESCRIPTION OF THE INVENTION

In one aspect, a method includes receiving x-ray data from a detector, and responding substantially in real time to the received data by controlling an object's exposure to x-rays.

In another aspect, a collimator includes at least one container, and at least one x-ray attenuating piece positioned within the container, the x-ray attenuating piece being RF field reactive.

In still another aspect, a system includes an energy source, an energy detector positioned to receive energy emitted from the source, at least one RF field reactive collimator positioned between the source and the detector, and a computer coupled to the detector and the RF field reactive collimator, wherein the computer is configured to generate images from data from the detector.

### BRIEF DESCRIPTION OF THE DRAWINGS

FIG. 1 illustrates a collimator.

FIG. 2 illustrates a plurality of collimators forming a three dimensional (3D) array.

FIG. 3 illustrates an individual unit when a field is not applied.

FIG. 4 illustrates an individual unit when a field is applied.

FIG. 5 illustrates how a three dimensional grid could be used to control the amount of attenuation that would take place along the path of the x-ray.

FIG. 6 illustrates a cardiac timing signal with desired acquisition windows, wherein the dosage is only applied within the windows.

FIG. 7 illustrates an imaging system with an associated display.

### DETAILED DESCRIPTION OF THE INVENTION

There are herein described methods and apparatus useful for imaging systems such as, for example, but not limited to an x-ray system. The apparatus and methods are illustrated with reference to the figures wherein similar numbers indicate the same elements in all figures. Such figures are intended to be illustrative rather than limiting and are included herewith to facilitate explanation of an exemplary embodiment of the apparatus and methods of the invention. Although, described in the setting of an x-ray system, it is contemplated that the benefits of the invention accrue to all diagnostic imaging systems and modalities such as PET, SPECT, fused systems such as a CT/PET and CT/SPECT and CT/MRI system, and/or any modality yet to be developed in which collimator plates are used.

The herein described methods and apparatus, are in one embodiment, a three dimensional array of liquid crystal display (LCD) like units. Each unit would operate in the following fashion. When an electric potential is applied to the unit, thin metal strips in suspension will align with the electric field. When the field potential is not applied, the metal strips will no longer align with the field and will be aligned randomly in the suspension. In one configuration, the unit will partially attenuate the transmission of x-rays passing through the unit. In the other configuration, the unit will allow transmission of the x-rays. The more random configuration will attenuate the x-rays more than the oriented configuration. However, clearly using x-ray attenuating material pieces that are RF (Radiofrequency) field reactive such that the pieces align when subjected to a field of sufficient strength and not be aligned when no field is present will result in a collimator that has different attenuation properties when subected to different RF field environments. Additionally, static magnetic-fields can also be used to align and, further, when not present, can allow random orientation or a second orientation. Also, it is contemplated the benefits of the invention accrue to all field reactive collimators and as used herein the term RF field refers to all spectrums of radiation and not just those frequencies know in the art as RF frequencies. Moreover, the attenuating devices, the ‘strips’ can be composite in nature e.g. one portion of the strips would serve to attenuate and a second portion of the strip would serve to respond to the electric, magnetic or RF field imposed.

FIG. 1 illustrates a collimator 10 including a container 12 holding a liquid suspension material 14 that is, in one embodiment, oil. At least one x-ray attenuating piece 16 is in the fluid 14. A switch 18 controls an electric field 20.

To minimize the attenuation of the x-rays in the off state, the Z level of the suspension can be minimized. However, it should be noted that the contribution of this fluid to overall attenuation would be minimal considering that the x-rays already pass through the oil layer in the known x-ray tubes. It is contemplated that the benefits of the invention accrue to embodiments where there would be no oil or liquid. This may allow the use of techniques that do not rely on the oil or liquid to allow a random orientation, e.g. the strips are allowed free orientation in a vacuum or air, with mechanical constraints on the motion such as pivots or other means.

To control the degree of attenuation through a particular path, it would be possible to change the applied electrical fields to a depth of units.

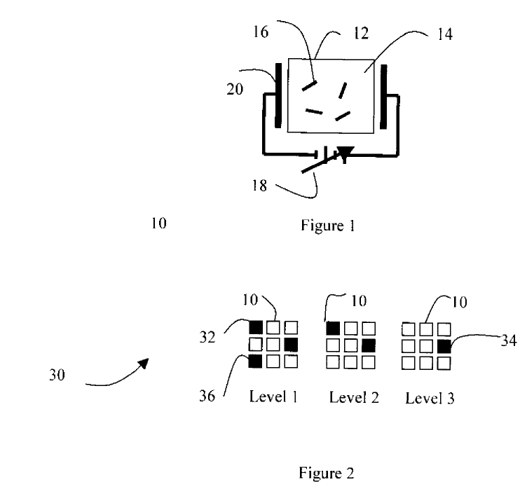

FIG. 2 illustrates a plurality of collimators 10 forming a three dimensional (3D) array 30. In this example, the block 32 in the upper left hand corner is attenuating x-rays for ⅔ of the depth for the entire array and as such would provide 66% of potential attenuation in this setup. The block 34 in right column of the middle row is attenuating x-rays in all 3 levels of the array and would provide 100% of potential attenuation, though it should be noted that depending on the overall depth of the array and the attenuation ability of the metal strips that this may not be 100% total attenuation. The block 36 in the left column of the third row only has ⅓ of the array attenuating x-rays and therefore would provide 33% of potential attenuation in this array.

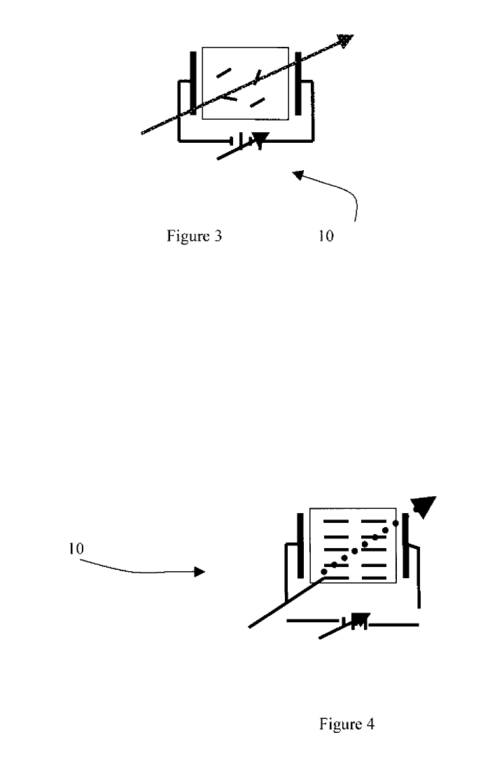

FIGS. 3 and 4 represents of how an individual unit would change if a field were not applied (FIG. 3) and when a field is applied (FIG. 4). FIG. 3 illustrates how the metal strips will distribute themselves randomly and allow passage of the x-rays through the unit, or at least minimize attenuation. FIG. 4 shows how the metal strips would align if a field is applied and creates a shutter effect that would attenuate the x-rays passing through this unit. Total attenuation would depend on the density of the metal used for the strips and how many strips are in the unit. This example is assuming that the off state is created by having the strips align with the field even though it has not been determined if this is the proper configuration for attenuation. Further experimentation will clarify which configuration will be used for attenuation. Additionally, it has not determined if temperature control will be needed. But should the metal strips or pieces of foil heat up and have deleterious effects either on longevity or attenuation properties, or there is any other reason for heat control, a heat sink or heat tube may be used keep collimator 10 at any desired temperature. Additionally, in the embodiments that utilize oil, the oil may be used as a coolant passing through a radiator or other heat exchanger. Collimator 10 and array 30 may independently be employed with existing x-ray machines.

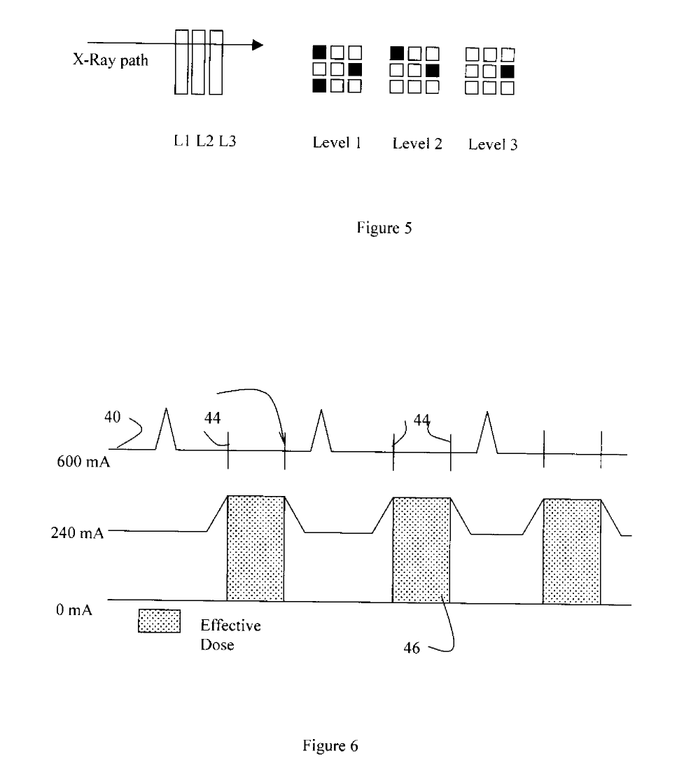

FIG. 5 illustrates how a three dimensional grid could be used to control the amount of attenuation that would take place along the path of the x-ray. If each unit can only attenuate 33% of the x-ray signal, one could stack three grids and control the individual units to control the net attenuation. Additionally the individual units could have different attenuation properties for different typical scans. For example, one for a head scan and a different one for a cardiac scan. One could also use a different number of blocks or individual units; for example, the units could be such that a user would use two for cardiac scans and add a third one for a head scan. Please note the spectral nature of the attenuation. Strips of one metal will attenuate lower energy x-rays more than higher energy ones while the ratio of low-to-high energy attenuation is different for another metal e.g. tungsten and aluminum.

This system could allow for real time dynamic control of x-ray dose to the patient. In an x-ray system, the digital detector could provide information about relative exposure levels in the field of view. If the patient is getting overexposed in one area while the true region of interest of the exam has not been exposed enough, it would be possible to turn on the necessary units in the array to lower the dose to the patient in the overexposed areas while still providing full exposure to underexposed areas. This real time technique would allow an x-ray system to maximize dose efficiency and potentially lower overall dose to the patient while still maximizing image quality.

A CT system could act in the same manner as described above to control dose to regions of a patient. This system could also allow the advantage of very fast on/off capabilities of the x-ray where temporal control of the signal is important. For example, with current cardiac scans the dose is changed over time by modulating the mA setting of the tube. The mA is raised during image acquisition periods and lowered during non-acquisition periods. One problem right now is that it is not possible to change the mA immediately and therefore there is a ramp of increasing or decreasing dose, which is effectively wasted. Secondly, the floor of the lowered mA is not 0, and is closer to 200 mA. Therefore, there are opportunities for dose reduction using a RF field reactive collimator.

FIG. 6 illustrates a cardiac timing signal 40 with desired acquisition windows 44, wherein the dosage 46 is only applied within windows 44. During non window periods, the dosage is zero. This system would allow one, if 100% potential attenuation were reached, to effectively turn the exposure to the patient on and off. This would benefit the patient, as it would allow for more accurate real time dose control to the entire field of view in addition to lowering the overall dose to the patient while preserving image quality.

Another possible application is with when using limited dynamic range detectors. For example, photon counting detectors may have ‘pile-up effects’. This causes the photon count to become less accurate overtime. By using this attenuator, you may be able to counter, or at least minimize, the pile-up effect by spatially limiting the flux. Note: there exists a detector saturation problem. Detector elements to one side of the patient or the other are often overexposed to the point of nearing saturation. The current energy integrating detectors aren't nearly so troublesome as photon-counting detectors foreseen for new machines. Nonetheless, lowering exposure of these detector elements removes or reduces certain imaging artifacts and lowers the number of corrections applied to clear the image of the artifacts and other measures that represent expense, time and complexity.

The estimated switching time of the device should be on the order of 0.10 ms, a 10× improvement over the current switching time available from the tube today. This should provide a large advantage in a wide variety of applications.

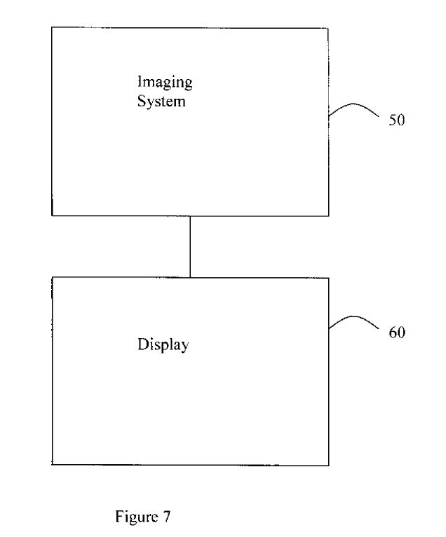

FIG. 7 illustrates an imaging system 50 with an associated display 60. Imaging system 50 can be of any modality, but in one embodiment, system 50 is a CT system. In another embodiment, system 50 is a dual modality imaging system such as a combined CT/PET. Display 60 can be separate from system 50 or integrated with system 50. System 50 includes an acquisition device such as an x-ray radiation detector, a Gamma Camera, an ultrasound probe and/or an MRI coil. In all the above modalities, please note that there is energy traveling at least partially through at least one component of a body and impinging an energy detector. A computer is coupled to the detector for processing the received data and producing an image if desired. The energy detector may include collimators as described herein.

Of course, the methods described herein are not limited to practice in system 50 and can be utilized in connection with many other types and variations of imaging systems. Although the herein described methods are described in a human patient setting, it is contemplated that the benefits of the invention accrue to non-human imaging systems such as those systems typically employed in small animal research. Although the herein described methods are described in a medical setting, it is contemplated that the benefits of the invention accrue to non-medical imaging systems such as those systems typically employed in an industrial setting or a transportation setting, such as, for example, but not limited to, a baggage scanning CT system for an airport or other transportation center.

In some known CT imaging system configurations, a radiation source projects a fan-shaped beam which is collimated to lie within an X-Y plane of a Cartesian coordinate system and generally referred to as an “imaging plane”. The radiation beam passes through an object being imaged, such as a patient. The beam, after being attenuated by the object, impinges upon an array of radiation detectors. The intensity of the attenuated radiation beam received at the detector array is dependent upon the attenuation of a radiation beam by the object. Each detector element of the array produces a separate electrical signal that is a measurement of the beam attenuation at the detector location. The attenuation measurements from all the detectors are acquired separately to produce a transmission profile.

In third generation CT systems, the radiation source and the detector array are rotated with a gantry within the imaging plane and around the object to be imaged such that an angle at which the radiation beam intersects the object constantly changes. A group of radiation attenuation measurements, i.e., projection data, from the detector array at one gantry angle is referred to as a “view”. A “scan” of the object includes a set of views made at different gantry angles, or view angles, during one revolution of the radiation source and detector.

To reduce the total scan time, a “helical” scan may be performed. To perform a “helical” scan, the patient is moved while the data for the prescribed number of slices is acquired. Such a system generates a single helix from a cone beam helical scan. The helix mapped out by the cone beam yields projection data from which images in each prescribed slice may be reconstructed.

Either in a helical or non-helical scan, the gantry rotation velocity can be changed. The herein described methods and apparatus allow that if the patient is getting overexposed in one area while the true region of interest of the exam has not been exposed enough, it would be possible to turn on the necessary units in the array to lower the dose to the patient in the overexposed areas while still providing full exposure to underexposed areas.

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

Technical effects include that the herein described methods and apparatus allow for that if the patient is getting overexposed in one area while the true region of interest of the exam has not been exposed enough, it would be possible to turn on the necessary units in the array to lower the dose to the patient in the overexposed areas while still providing full exposure to underexposed areas.

Exemplary embodiments are described above in detail. The assemblies and methods are not limited to the specific embodiments described herein, but rather, components of each assembly and/or method may be utilized independently and separately from other components described herein.

While the invention has been described in terms of various specific embodiments, those skilled in the art will recognize that the invention can be practiced with modification within the spirit and scope of the claims.

What is claimed is:

1. A method comprising:
receiving x-ray data from a detector; and
responding substantially in real time to the received data by controlling an object's exposure to x-rays.

2. A method in accordance with claim 1 wherein said responding comprises controlling a plurality of RF field reactive collimators.

3. A method in accordance with claim 1 wherein said responding comprises controlling a plurality of RF field reactive collimators positioned in a 3D array.

4. A method in accordance with claim 3 wherein each RF field reactive collimator comprises a plurality of attenuating material pieces in a suspension.

5. A method in accordance with claim 4 wherein the attenuating material is a metal.

6. A method in accordance with claim 5 wherein the suspension is a suspension of oil.

7. A collimator comprising:
at least one container; and
at least one x-ray attenuating piece positioned within said container, said x-ray attenuating piece being RF field reactive.

8. A collimator in accordance with claim 7 further comprising a plurality of containers wherein each container holds at least one x-ray attenuating piece positioned within said containers, each said x-ray attenuating piece being RF field reactive.

9. A collimator in accordance with claim 7 further comprising a plurality of containers arranged in a 3D array, wherein each container holds at least one x-ray attenuating piece positioned within said containers, each said x-ray attenuating piece being RF field reactive.

10. A collimator in accordance with claim 8 further comprising a liquid suspension material in each said container.

11. A collimator in accordance with claim 9 further comprising a liquid suspension material in each said container.

12. A collimator in accordance with claim 7 further comprising a liquid suspension material in said container.

13. A collimator in accordance with claim 7 wherein the x-ray attenuating piece comprises a metal.

14. A collimator in accordance with claim 7 wherein a plurality of x-ray attenuating pieces is positioned within said container.

15. A system comprising:
an energy source;
an energy detector positioned to receive energy emitted from said source;
at least one RF field reactive collimator positioned between said source and said detector; and
a computer coupled to said detector and said RF field reactive collimator, said computer configured to generate images from data from said detector.

16. A system in accordance with claim 15 wherein said computer controlling a plurality of RF field reactive collimators.

17. A system in accordance with claim 16 wherein said plurality of RF field reactive collimators comprising a plurality of containers arranged in a 3D array, wherein each container holds at least one x-ray attenuating piece positioned within said containers, each said x-ray attenuating piece being RF field reactive.

18. A system in accordance with claim 17 further comprising a liquid suspension material in each said container.

19. A system in accordance with claim 18 wherein the x-ray attenuating piece comprises a metal.

20. A system in accordance with claim 19 wherein said liquid suspension material comprises oil.
